(19) United States
(12) Patent Application Publication
(10) Pub. No.: US 2011/0007066 A1
(43) Pub. Date: Jan. 13, 2011

(54) DATA TRANSMITTING METHOD FOR TRANSMITTING DATA BETWEEN TIMING CONTROLLER AND SOURCE DRIVER OF DISPLAY AND DISPLAY USING THE SAME

(76) Inventors: Chin-Tien Chang, Sinshih Township (TW); Ying-Lieh Chen, Sinshih Township (TW)

Correspondence Address: HAYES SOLOWAY P.C., 3450 E. SUNRISE DRIVE, SUITE 140, TUCSON, AZ, 85718, US

(21) Appl. No.: 12/501,211

(22) Filed: Jul. 10, 2009

(51) Int. Cl. G09G 5/00

(52) U.S. Cl. 345/214; 345/87

(57) ABSTRACT

A data transmission method for transmitting data between a timing controller and a source driver of a display and a display using the same are disclosed. The transmission method includes recognizing a start of a blank period of a frame period; sampling de-skew data on a data bus during the blank period based on a data clock; performing a de-skew function by comparing the sampled de-skew data with a predetermined de-skew code and adjusting the data clock; recognizing a start of a data input period of the frame period; and sampling pixel data on the data bus during the data input period based on the adjusted data clock. The display includes a timing controller, a data bus, and a source driver. The source driver is connected to the timing controller via the data bus for performing the data transmission method.

### FIELD OF THE INVENTION

This invention relates to a data transmission method, and more particularly, to a data transmitting method for transmitting data between a timing controller and a source driver of a display.

### BACKGROUND OF THE INVENTION

A liquid crystal display (LCD) system usually includes a timing controller, drivers and an LCD array that is organized according to rows and columns. The timing controller receives video data and generates the necessary timing signals to the drivers for selectively driving pixels in the LCD system. The drivers include at least one source driver and gate drivers.

To improve the image quality, the resolution and the refresh rate are getting higher, however, skew problem may arise due to the higher transmission rate.

### SUMMARY OF THE INVENTION

Therefore, the present invention presents a transmission method to provide a transmission protocol and a de-skew method for a display, and a display using the transmission protocol and the de-skew method.

According to an embodiment of the present invention, the transmission method includes recognizing a start of a blank period of a frame period: sampling de-skew data on a data bus during the blank period based on a data clock; performing a de-skew function by comparing the sampled de-skew data with a predetermined de-skew code and adjusting the data clock; recognizing a start of a data input period of the frame period; and sampling pixel data on the data bus during the data input period based on the adjusted data clock.

According to another embodiment of the present invention, the display includes a timing controller, a data bus, and a source driver. The source driver is connected to the timing controller via the data bus for first recognizing a start of a blank period of a frame period, sampling de-skew data on the data bus during the blank period based on a data clock for performing a de-skew function, and then sampling pixel data on the data bus during a data input period, wherein the source driver performs the de-skew function by comparing the sampled de-skew data with a predetermined de-skew code.

### BRIEF DESCRIPTION OF THE DRAWING

The foregoing aspects and many of the attendant advantages of this invention will become more readily appreciated as the same becomes better understood by reference to the following detailed description, when taken in conjunction with the accompanying drawings, wherein:

FIG. 1 is a structure diagram showing a display device according to one embodiment of the present invention;

FIG. 2 is a timing diagram of the data transmitted by the timing controller to the source driver during a first frame period according to one embodiment of the present invention;

FIG. 3 is a timing diagram of the blank period shown in FIG. 2;

FIG. 4 is a timing diagram showing the data input period shown in FIG. 2; and

FIG. 5 is a flow chart showing a data transmission method for transmitting data between the timing controller and the source driver of the display according to one embodiment of the present invention of the present invention.

### DETAILED DESCRIPTION OF THE PREFERRED EMBODIMENT

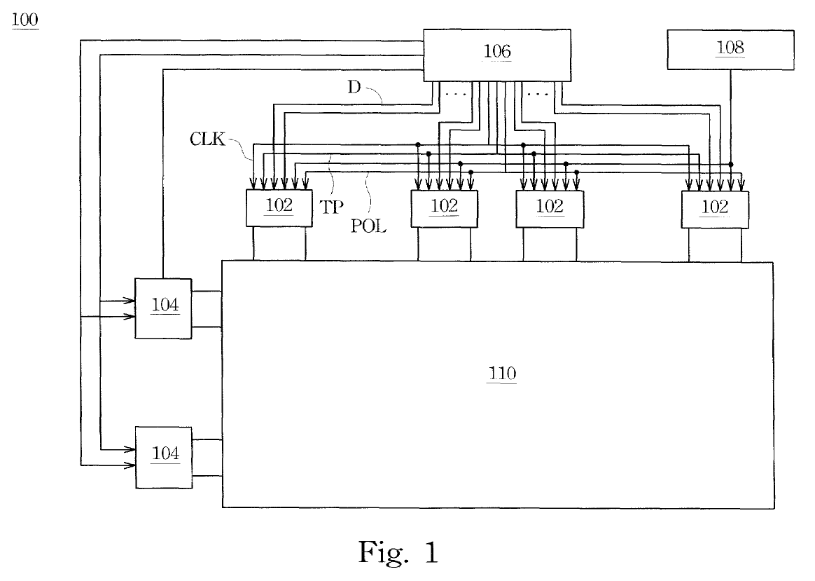

In order to make the illustration of the present invention more explicit and complete, the following description is stated with reference to FIG. 1 through FIG. 5.

FIG. 1 is a structure diagram showing a display 100 according to one embodiment of the present invention. The display 100 comprises at least one source drivers 102, at least one gate drivers 104, a timing controller 106, a gamma reference generator 108 and a panel 110. The timing controller 106 sends display data and controls signals to the source drivers 102 via transmission lines. The control signals include a polarity signal POL for controlling the polarities of pixels of the panel 110. The control signals also include a latch signal TP for the source drivers to output driving signals to the panel 110. It is noted that the at least one data bus D may be differential pairs or single transmission lines, and is used to transmit pixel data 205. In addition, the control signals include a data clock CLK.

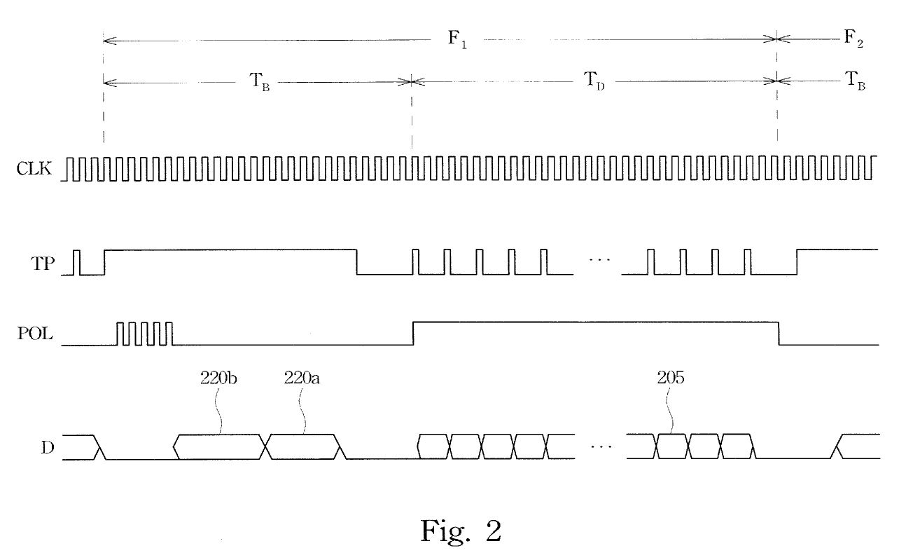

FIG. 2 is a timing diagram of the data transmitted by the timing controller to the source driver during a first frame period F₁ according to one embodiment of the present invention. In this embodiment, each of the first frame periods F₁ and a second frame F₂ includes a blank period T_{B} and a data input period T_{D}. During the blank period T_{B}, or named vertical blanking interval (VBI), the timing controller 106 transmits setting data via the data bus D for the source driver 102, and the setting data, for example, includes register data 220b for setting the register of the source driver, and de-skew data 220a for the source driver 102 to de-skew. During the data input period, the timing controller 106 transmits pixel data 205 via the data bus D. This embodiment of the invention utilizes the blank period to transmit setting data via the data bus, such that the number of transmission lines between the timing controller 106 and the source driver 102 is reduced.

It is noted that the data clock CLK shown in FIG. 2 is merely shown as an example for explaining the embodiment of the present invention. In fact, the frequency of the data clock CLK can be a few times as much as that illustrated in FIG. 2.

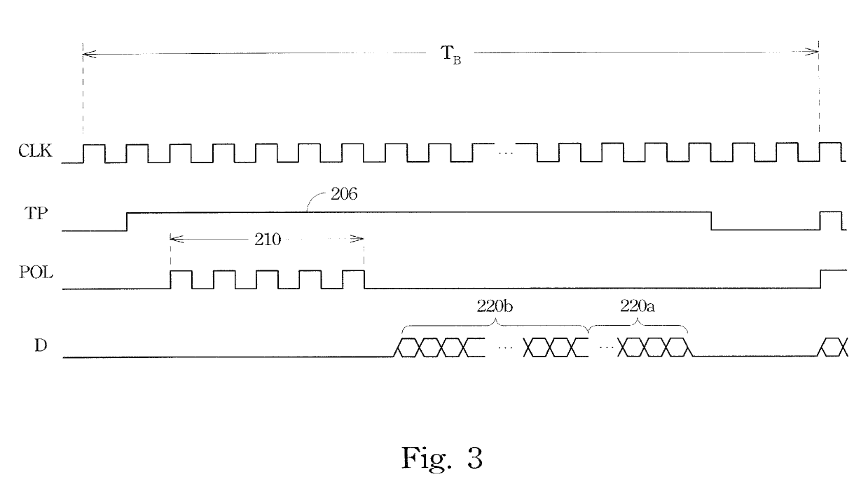

FIG. 3 is a timing diagram of the blank period T_{B} shown in FIG. 2. The start of the blank period T_{B} is, for example, recognized by checking the states of the latch signal TP and the polarity signal POL. In this embodiment, the blank period T_{B} is recognized by a pulled-high latch signal TP and a toggling polarity signal POL in the period 210. After recognizing the blank period T_{B}, the source driver 102 starts to receive the setting data, which is, in this example, the register data 220b and the de-skew data 220a.

The source driver 102 receives the register data 220b to set its own parameters. Since de-skew is not performed yet, the register data 220b can be sent from the timing controller 106 by another clock with lower frequency compared to the data clock CLK, and then the register data 220b can be sampled by the source driver 102 based on the data clock CLK which has higher frequency to ensure the correctness of sampling the register data 220b.

It is worth noticing that the de-skew data 220b in this embodiment is sent via the data bus in the blank period T_{B}, and the source driver 102 does the de-skew function at the same time. The timing controller 106 and the source driver 102 both know a pre-determined de-skew code. The timing controller 106 sends the de-skew code via the data bus D during the blank period T_{B}. Then the source driver 102 samples the de-skew data 220a to check if the sampled de-skew data 220a corresponds to the pre-determined de-skew code. If the sampled de-skew data 220a does not correctly corresponds to the pre-determined de-skew code, the source driver can fine-tune the data clock CLK. The source driver can perform the above de-skew function at the initial stage after powered-on of the LCD, or selectively at every or some blank periods. Further the source driver may include a memory for storing the pre-determined de-skew code.

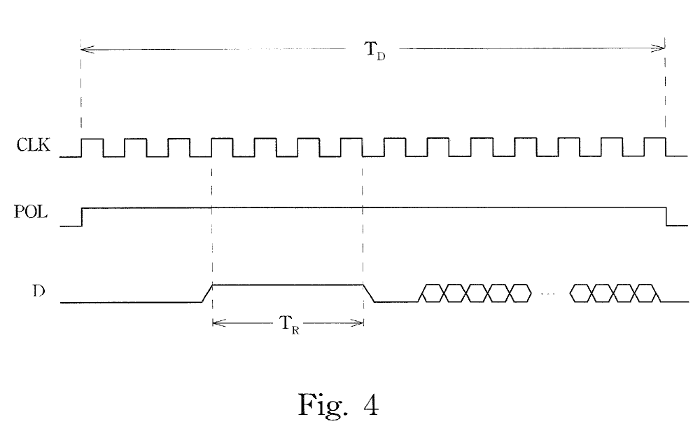

FIG. 4 is a timing diagram showing the data input period T_{D} shown in FIG. 2. The data input period T_{D} can be recognized, in this embodiment, by counting a predetermined number of clocks and detecting the data bus to be pulled high for the reset period T_{R}. Then the source driver 102 receives the pixel data 205 to drive the panel 110.

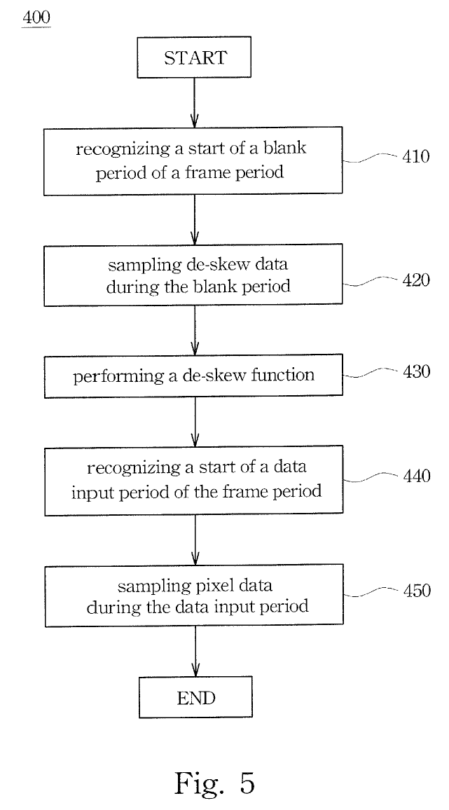

FIG. 5 is a flow chart showing a data transmission method 400 for transmitting data between the timing controller 106 and the source driver 102 of the display 100 according to one embodiment of the present invention of the present invention. In the method 400, the start of the blank period T_{B} is recognized, for example, by checking the states of the latch signal TP and the polarity signal POL in a step 410. Then, the de-skew data 220a on the data bus D is sampled during the blank period T_{B} based on the data clock CLK in a step 420. Thereafter, the de-skew function is performed by comparing the sampled de-skew data with the predetermined de-skew code and adjusting the data clock CLK in a step 430. Then, the start of the data input period T_{D} of the first frame period F₁ is recognized in a step 440. Thereafter, the pixel data 205 on the data bus D is sampled during the data input period T_{D} based on the adjusted data clock in a step 450.

It is noted that, the register data 220b can be further sampled during the blank period T_{B} to initialize the source driver 102 in a step performed after the step 410 and before the step 420.

In view of the above description, the embodiments of the present invention use the data bus to transmit data for register data and de-skew data during a vertical blanking interval, thereby the embodiments of the present invention do not need additional transmission lines to transmit the register data and the de-skew data. In addition, because the de-skew data is transmitted with another clock has lower frequency compared to original data clock, the reliability of the de-skew function can be greatly increased.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. A data transmission method for transmitting data between a timing controller and a source driver of a display, comprising:
recognizing a start of a blank period of a flame period;
sampling de-skew data on a data bus during the blank period based on a data clock;
performing a de-skew function by comparing the sampled de-skew data with a predetermined de-skew code and adjusting the data clock;
recognizing a start of a data input period of the frame period; and
sampling pixel data on the data bus during the data input period based on the adjusted data clock.

2. The data transmission method of claim 1, further comprising a step for sampling register data on the data bus during the blank period to initialize the source driver.

3. The data transmission method of claim 2, wherein the register data is sent by the timing controller by a clock with lower frequency compared to that of the data clock.

4. The data transmission method of claim 3, wherein the register data is sampled by the source driver based on the data clock.

5. The data transmission method of claim 3, wherein the step for recognizing the start of the blank period comprises detecting states of a latch signal and a polarity signal.

6. The data transmission method of claim 5, wherein the step for recognizing the start of the blank period comprises detecting the latch signal being pulled high and the polarity signal toggling for a period.

7. The data transmission method of claim 1, wherein the blank period is a vertical blanking interval.

8. The data transmission method of claim 1, wherein the step for recognizing the start of the data input period comprises counting a number of the data clock and then detecting the data bus to be pulled high for a reset period.

9. A display, comprising:
a timing controller;
a data bus;
a source driver, connected to the timing controller via the data bus, first recognizing a start of a blank period of a frame period, sampling de-skew data on the data bus during the blank period based on a data clock for performing a de-skew function, and then sampling pixel data on the data bus during a data input period;
wherein the source driver performs the de-skew function by comparing the sampled de-skew data with a predetermined de-skew code.

10. The display of claim 9, wherein the source driver adjusts the data clock according to the comparison result, and sampling the pixel data based on the adjusted data clock.

11. The display of claim 9, wherein the source driver recognizes a start of the data input period of the frame period by counting a number of the data clock and then detecting the data bus to be pulled high for a reset period.

12. The display of claim 9, wherein the source driver further samples register data on the data bus during the blank period to initialize the source driver.

13. The transmission method of claim 12, wherein the register data is sent by the timing controller by a clock with lower frequency compared to that of the data clock.

14. The display of claim 13, wherein the register data is sampled by the source driver based on the data clock.

15. The display of claim 9, wherein the source driver recognizes the start of the blank period by detecting states of a latch signal and a polarity signal.

16. The display of claim 15, wherein the source driver recognizes the start of the blank period by detecting the latch signal being pulled high and the polarity signal toggling for a period.

17. The display of claim 9, wherein the blank period is a vertical blanking interval.

18. The display of claim 1, wherein the source driver recognizes a start of the data input period comprises counting a number of the data clock and then detecting the data bus to be pulled high for a reset period.
